(19) United States
(12) Patent Application Publication
(10) Pub. No.: US 2013/0011662 A1
(43) Pub. Date: Jan. 10, 2013

(54) MOLDING COMPOUND OR COATING SYSTEM (PMMA-FREE) HAVING IR-REFLECTING PROPERTIES IN COMBINATION WITH A SURFACE LAYER OR FILM CONTAINING PMMA

(75) Inventors: Elisabeth Clamer, Darmstadt (DE); Michael Enders, Dieburg (DE); Achim Neuhaeuser, Mainz (DE)

(73) Assignee: EVONIK ROEHM GmbH, DARMSTADT (DE)

(21) Appl. No.: 13/636,370

(22) PCT Filed: Apr. 28, 2011
(86) PCT No.: PCT/EP2011/056691

§ 371 Date: Sep. 21, 2012

(30) Foreign Application Priority Data
May 20, 2010 (DE) 10 2010 029 169.2

(51) Int. Cl. B32B 27/36; B32B 5/16; B32B 27/30

(52) U.S. Cl. 428/323; 428/412; 428/421; 428/474.4; 428/522; 428/339

(57) ABSTRACT

The invention relates to opaquely coloured, infrared-reflecting mouldings which are able to serve as an IR barrier layer and can be used, for example, in the construction trade or in automotive engineering as, for example, a vehicle roof module with thermal protection properties.

### FIELD OF THE INVENTION

The invention relates to opaquely coloured, infrared-reflecting mouldings which are able to serve as an IR barrier layer and can be used, for example, in the construction industry or in automotive engineering as, for example, a vehicle roof module with thermal protection properties.

On account of the very good properties of PMMA, the corresponding moulding compositions are processed inter alia to form coextrusion layers or as top layers of in-mould-coated (IMC) parts. These layers serve as a top layer on, among others, films, sheets, profiles and pipes in which the main component and/or backing layer is composed of plastics, which in some cases are different plastics. These plastics, such as PVC, polystyrene, polycarbonate, ABS and ASA, for example, have further important properties, such as impact strength and/or low price.

Applications contemplated for these coloured coextrudates or IMC articles include, for example, construction applications, such as drainpipes and window frames; automotive applications, such as roof modules, exterior and interior trim components (panels), spoilers and mirror housings; household and sports applications, such as tool covers, outer panels for boats and ski foils. A problem with these coloured coextruded or IMC articles, however, is that often they are IR-absorbing and hence, for example, a vehicle interior heats up readily as a result of a roof module of this kind.

### PRIOR ART

To prevent such heating, the use is known of opaquely but IR-transparently coloured poly(meth)acrylate (PMMA) moulding compositions for the weathering protection of plastics mouldings made, for example, of polyvinyl chloride (PVC). The coated plastics moulding is then given a colorant such as TiO₂, for example, which reflects the IR radiation at the boundary layer between the two plastics mouldings and so prevents excessive heating of the article.

DE 27 19 170 describes a method for protecting PVC layers against sunlight effects, by means of a layer which is applied durably to the PVC layer and which is equipped both with UV stabilizers and with IR reflectors. IR reflectors used are lead chromate, molybdate red, molybdate orange, chromium oxide green, antimony sulphide, cadmium sulphoselenide, cadmium sulphide, anthraquinone black pigment, anthraquinone dark-blue pigment, monoazo pigment or phthalocyanines. Some of these pigments are no longer permitted today. As material for the top layer, an otherwise unspecified PMMA is described.

DE 26 05 325 likewise describes a method for protecting PVC surfaces: the applied protective layer is given opaque colouring in such a way as to achieve maximum reflection in the IR region and minimum transparency in the UV region. The objective is achieved through the use of at least one IR-reflecting black or colour pigment. For the darker colour pigments, predominantly IR-absorbing pigments are not used. A pigment used in the examples is titanium dioxide or anthraquinone black in combination with a UV absorber.

WO 2009 097 205 describes a coating composition comprising IR-reflecting nanoparticles and a triblock copolymer-based dispersing additive suitable therefor. WO 2008 097 895 and WO 2009 097 205 describe a three-layer automotive finish comprising colour pigments in one layer and IR-reflector pigments in another layer. Neither system is suitable for producing trim components or shaped parts. An objective of these applications is to provide black finishes which heat up to a reduced extent in spite of the dark colour.

A moulding composition, also in single-layer form, comprising colour pigments and IR-reflector pigments is found in EP 18 173 75. A similar system is described in DE 10 2007 061 052. Single-layer systems, however, also have the disadvantage that the design freedom is greatly restricted, and that sufficient heat distortion resistance in combination with good weathering resistance is difficult to realize.

A multi-layer transparent system of two PMMA layers joined by a PU adhesive and with IR-absorbers in one PMMA layer is found, additionally, in EP 20 323 60. This system, however, is colourless and, while being less transmissive for heat and correspondingly shaded systems, is nevertheless too transparent particularly as glazing for vehicles or vehicle roofs. A similar non-transparent, coloured variant is not described. Pure PMMA systems, however, may undergo alteration at temperatures above 100° C., more precisely above 105° C. Thus there may be instances of hazing or distortion of the shaped part. Particularly in the case of outdoor applications under direct insolation, this is a disadvantage for dark-coloured components that heat up readily.

Corresponding, single-layer moulding compositions comprising IR-reflector pigments and dark colour pigments and composed of polymethacrylates or ASA (acrylonitrile-styrene-alkyl acrylate terpolymers) are found in US 2007 01 294 70 and in US 2007 01 294 82. In dimensional terms, these single-layer moulding compounds also have only limited thermal stability and are therefore not suitable for particularly dark vehicle trim components.

A corresponding system with a top layer and a backing layer of PVC, PE or PP is described in EP 19 163 52. These plastics as well, however, are no longer dimensionally stable when subject to particular development of heat at 100° C. Often these materials undergo alteration even at temperatures of more than 85° C. Applications described are, in particular, building applications, such as PVC window frames, but not automotive engineering. Latter applications, however, are subject to relatively exacting requirements in terms both of heat resistance and of visual appearance.

EP 18 173 83 describes a single-layer system comprising a shaped plastics part, a paint layer, a fibre material, a hydraulically setting material such as concrete or a composite material. IR-reflection may be achieved in ways which include the addition of reflecting pigments and dyes which, in conjunction with corresponding disadvantages, are located necessarily in the same layer. Any dyes are located in the same layer. EP 18 173 83 provides teaching as to how to equip covered parts in a vehicle interior, such as leather seats or fittings or else structural components such as pantiles, window frames and even facades in such a way that they exhibit little heating-up when their colour is dark. EP 18 173 83, however, does not provide teaching on how to produce a visually appealing shaped part, as a roof module in a vehicle, for example. Moreover, this teaching is probably not sufficient to meet the exacting requirements in relation to a) high radiation load and b) particularly effective heat insulation of a vehicle interior, through a roof module, for example.

### OBJECT

An object of the present invention was to provide darkly and opaquely coloured shaped plastics parts for outdoor applications that in comparison with the prior art are at least equivalent but preferably are improved in terms of their properties. The intention more particularly is to provide shaped plastics parts which by comparison with the prior art can be designed with greater variability in terms of optical design, weather resistance or tactile qualities and which exhibit a high temperature resistance up to more than 100° C.

By dark shades are meant brown, grey, dark-green, dark-blue or black shades; mixed shades are likewise possible.

The object, furthermore, was to provide dark-coloured shaped plastics parts which minimize heating of the shaped plastics part or of a region which is situated behind the shaped plastics parts from the viewpoint, for example, of insolation.

The object, furthermore, was that the plastics moulding must be weather-resistant independently of the colouring.

A further requirement imposed on the dark-coloured shaped part was that the adhesion in said part between top layer and plastics moulding to be coated must be ensured to be effective and durable.

Furthermore, the coloured or colourless moulding compositions are to have good processing properties and are to be stable at the processing temperature.

### SOLUTION

The solution to achieving these objects is provided through an innovative, dark-coloured plastics moulding which exhibits little heating-up and which features the following properties:
a. The plastics moulding is composed of at least two layers, a backing layer and a top layer.
b. The top layer is a transparent plastics layer.
c. The backing layer is a polymer layer which has particular heat distortion stability up to at least 100° C.
d. An inorganic, IR-reflecting pigment, which is present in a layer which is not the top layer.

It is important that the plastics moulding has a total solar reflectance (TSR) of at least 10%, preferably of at least 15% and more preferably of at least 20%. The TSR is in accordance with ASTM E903-96, the standard test method for solar absorption, reflection and transmission for Materials Using Integrating Spheres.

The top layer of a transparent plastic may be a top layer of polyamide (PA), polyvinyl fluoride (PVF), polyvinyl dichloride (PVDF), polycarbonate (PC), alkyl acrylate-styrene-acrylonitrile terpolymer (ASA), styrene-acrylonitrile copolymer (SAN) or poly(meth)-acrylate. It is preferably a poly(meth)acrylate layer. Poly(meth)acrylates are known in the art. These polymers are obtained generally by radical polymerization of mixtures comprising (meth)acrylates. The expression (meth)acrylates encompasses methacrylates and acrylates and also mixtures of both. Preferred poly(meth)acrylates are obtainable by polymerization of mixtures which have a methyl methacrylate content of at least 20% by weight, more particularly at least 60% by weight and more preferably at least 80% by weight, based in each case on the total weight of the monomers to be polymerized.

The poly(meth)acrylate layer is with particular preference a PMMA layer. In this case it may be, alternatively, a PMMA film, having a thickness of between 15 and 150 μm, or a PMMA sheet, having a thickness of between 0.15 and 25 mm. One example of the PMMA component is the moulding composition Plexiglas® 7H. It is available commercially from Evonik Röhm GmbH.

The top layer may further comprise further polymers, and hence take the form of a polymer blend, in order to modify the properties. Such further polymers include, among others, PA, PVF, PVDF, ASA, polyacrylonitriles, polystyrenes, polyethers, polyesters, polycarbonates and polyvinyl chlorides. These polymers may be used individually or as a mixture, and copolymers derivable from the aforementioned polymers may also be added to the moulding compositions. Such copolymers include, in particular, styrene-acrylonitrile polymers (SAN), which are added preferably to the moulding compositions in an amount of up to 45% by weight. Particularly preferred styrene-acrylonitrile polymers may be obtained through the polymerization of mixtures which are composed of 70% to 92% by weight of styrene, 8% to 30% by weight of acrylonitrile and 0% to 22% by weight of further comonomers, based in each case on the total weight of the monomers to be polymerized.

The weight-average molecular weight M̅_̅{̅w̅}̅ of the homo-polymers and/or copolymers for use as matrix polymers in accordance with the invention may fluctuate within wide ranges, the molecular weight normally being tailored to the end use and to the way in which the moulding composition is to be processed. Generally speaking, however, said weight is in the range between 20 000 and 1 000 000 g/mol, preferably 50 000 to 500 000 g/mol and more preferably 80 000 to 300 000 g/mol, without any intention that this should constitute a restriction.

The backing layer is a layer composed of a thermoplastic polymer which has particular heat distortion resistance up to at least 100° C., preferably up to at least 110° C. Preferred thermoplastic polymers are, in particular, polyesters, polyamides, ASA, styrene-acrylonitrile (SAN), thermoplastic polyurethanes, polycarbonates, acrylonitrile-butadiene-styrene terpolymer (ABS), polyoxymethylene (POM), PVF, PVDF, cycloolefin (co)polymers (COP or COC) or mixtures of these polymers, and polymer mixtures which comprise at least 50% by weight of at least one of these polymers. The backing layer can have a thickness of between 15 μm and 25 mm.

An alternative possibility as backing layer is to use thermosets produced on the basis of melamine, epoxide or phenyl.

In one inventive embodiment the backing layer comprises at least one inorganic, IR-reflecting pigment. In a preferred embodiment where there is only one inorganic, IR-reflecting pigment present in the moulding, said pigment may be in the backing layer.

In an alternative embodiment, the plastics moulding additionally comprises a further layer. This further layer is preferably an adhesive layer having a thickness of between 1 and 100 μm. With particular preference the adhesive layer is located between the top layer and the backing layer.

In an alternative embodiment of the present invention the inorganic, IR-reflecting pigment is located inter alia, preferably exclusively, in the adhesive layer.

The adhesive layer may comprise an adhesive system or an adhesion-promoter system. Use may be made more particularly of polyurethane adhesives, butadiene-styrene copolymers, or terpolymers comprising butadiene and styrene, or else of polyacrylates, epoxides or other adhesives or adhesion promoters. The choice of appropriate adhesive is made by the skilled person in accordance with the two substrates to be joined—for example, on the basis of the materials of the backing layer and of the top layer.

The layer equipped with the inorganic, IR-reflecting pigment comprises, in accordance with the invention, between 0.01% and 5.0% by weight, preferably between 0.05% and 3.0% by weight, and very preferably between 0.1% and 2.0% by weight, of this pigment. This inorganic, IR-reflecting pigment is preferably a metal oxide having a particle size of between 50 nm and 5.0 μm, preferably between 100 nm and 3.0 μm and more preferably between 200 nm and 2.5 μm.

Through the use of one or different infrared (IR)-reflecting inorganic colour pigments in the mouldings of the invention it is possible to achieve significantly higher total solar reflectances under insolation than with mouldings coated with or composed of conventionally darkly coloured polymers.

It has now been found that by the use of pigments of the following classes

| CAS Number | C.I. Name | C.I. Number | Chemistry |
|---|---|---|---|
| 68186-85-6 | C.I. pigment | C.I. 77377 | Cobalt titanate |
| | green 50 | | green spinel |
| 68909-79-5 | C.I. pigment | C.I. 77288 | Hematite chromium |
| | green 17 | | green |
| | | | black |
| 109414-04-2 | C.I. pigment | | Chromium iron oxide |
| | brown 29 | | |
| 68187-09-7 | C.I. pigment | C.I. 77501 | Iron chromite brown |
| | brown 35 | | spinel |
| 71631-15-7 | C.I. pigment | C.I. 77504 | Nickel iron chromite |
| | black 30 | | black spinel |

C.I. nomenclature according to Colour Index, The Society of Dyers and Colourists (SDC)

in polymers it is possible to produce darkly opaquely coloured moulding compositions without the plastics moulding equipped therewith or moulding produced therewith undergoing excessive heating in sunlight. The “dark” quality may be defined by means of the L* value in accordance with DIN 6174 (01/1979): Colorimetric determination of colour differences for masstone colours by the CieLAB formula. For the darkly opaquely coloured moulding compositions, the CieLab L* value is below 51, preferably below 41 and very preferably below 31.

WO 00/24817 (ferro) describes corundum-hematite structures which incorporate oxides of aluminium, antimony, bismuth, boron, chromium, cobalt, gallium, indium, iron, lanthanum, lithium, magnesium, manganese, molyb-denum, neodymium, nickel, niobium, silicon and/or tin.

The heat-distortion-resistant, IR-radiation-reflecting plastics mouldings of the invention can be employed in numerous sectors, particularly in the construction industry or in vehicle construction. The mouldings are employed preferably in elements in modules for facades, building roofs and vehicle roofs, or in parts for installation in or on vehicles. In such applications, the plastics mouldings may be installed with either the backing layer or the top layer on the outside. The outside in this case is the side which is exposed to the greater irradiative load, generally the greater thermal radiation load. Generally speaking, therefore, the outside is the sun side.

In an alternative use, the plastics mouldings of the invention may also be applied to a substrate. These substrates may be, for example, glass, concrete, masonry, wood or metal. In this case there is an application as an IR-reflecting surface cladding, in the construction industry, for example.

The plastics mouldings of the invention may also alternatively be combined with further plastics to form composite plastics materials. For this purpose, the plastics mouldings are applied to the second plastics moulding with the aid of conventional methods such as foam backing, in-mould coating, laminating or adhesive bonding. Alternatively or additionally it is also possible to apply at least one further plastics layer to the plastics moulding of the invention, with the aid of the methods recited.

The colorants or colorant mixtures which are present in one of the layers, preferably in the top layer, are additionally used for varying and harmonizing the colour. These colorants may be IR-reflecting, such as titanium dioxide, for example, or IR-transparent. The colorants, furthermore, may be organic dyes or further organic and inorganic pigments, and/or else mixtures thereof.

The fraction of these additional colorants may be between 0% and 3.0% by weight, preferably between 0% and 2.5% by weight and more preferably between 0% and 2.0% by weight, based on the matrix of the top layer.

The mouldings may be produced, for example, as follows: colorant(s) and moulding composition of the top layer are homogenized in the form of dryblend and subsequently processed by extrusion to form a film or a sheet.

The backing layer can be produced accordingly, comprising the IR-reflecting pigment, depending on embodiment.

Subsequently, one of the two layers is first provided with an adhesive layer, by means of rollers, and then is joined to the second layer.

Alternatively, all of the layers can be coextruded in one step—and provided, depending on embodiment, with an adhesive layer or adhesion-promoter layer.

The mouldings (synonymously plastics mouldings) of the invention are tested as follows: first of all, press plaques in a thickness of 0.5 mm are produced from the coloured and transparent mouldings, using a press. The individual press plaques are subsequently compressed to form a two-layer construction.

### EXAMPLES

The PLEXIGLAS® standard moulding composition is extruded using an extrusion mould as per FIG. 1, composed of press ring (1), displacer disc (4), bottom plate (3) and top plate (2), the bottom plate having an interior diameter of 50 mm. Also used are two temperature-regulated hot plates (2000 W), a hydraulic press, and a temperature sensor with alarm function.

General procedural instructions for producing the specimens.

One hot plate is set to a temperature of 250° C. 14 g of a standard moulding composition (for indication of material see individual example) are inserted into the top chamber of the extrusion mould, and the mould is placed on the hot plate. The temperature sensor is inserted into a receiver bore which is present in the press ring (1). A second hot plate is placed onto the extrusion mould in such a way that the mould is heated both from the bottom and from the top. When the temperature of the extrusion mould reaches a figure of 210° C., the hot extrusion mould is taken from the hot plates and placed in a hydraulic press. Here, the mould is compressed immediately with a pressure of 100 kN, causing part of the melt to flow from the top chamber into the bottom chamber.

After cooling to room temperature, the mould is turned round on a demoulding ring and put back into the press, where it is demoulded with the aid of a ram (diameter <40 mm). The moulding produced in this way is taken off with the pressing plate, and constitutes the backing layer.

In this way, by further compression, a PMMA outer layer having a thickness of 750 μm is applied. The outer layer used is PLEXIGLAS® Film 99524.

### Example 1

As colourless plastics pellets (standard moulding composition), the blend Cyrex® EXP-310 from Evonik Cyro LLC is used. It is admixed with 1% by weight of IR-reflecting pigment (Ferro PK 10204) and compounded by means of an extruder. The coloured plastics pellets produced are compression-moulded to give a circular disc having a diameter of 120 mm and a thickness of 4 mm.

### Example 2

As colourless plastics pellets (standard moulding composition), the blend Makrolon® 2607 from Bayer

Material Science is used. It is admixed with 1% by weight of IR-reflecting pigment (Ferro PK 10204) and compounded by means of an extruder. The coloured plastics pellets produced are compression-moulded to give a circular disc having a diameter of 120 mm and a thickness of 4 mm.

### Comparative Example 1 (CE1)

For comparison, PLEXIGLAS® 8N was compressed with 1% by weight of IR-reflecting pigment (Ferro PK 10204) in the same way as for Examples 1 and 2. In this case, however, there was no second compression with a PMMA outer layer, and so the specimen subjected to measurement was a one-layer system according to the prior art.

On these specimens, the heat distortion resistance temperature (HDT) was determined in accordance with ISO 75, and the Total Solar Reflectance (TSR) was calculated in accordance with ASTM E 903, based on optical measurements by means of photospectrometry (measured with a Varian Cary 5000) on the PMMA-coated side.

| | CE1 | Example 1 | Example 2 |
|---|---|---|---|
| HDT | 101° C. | 109° C. | 122° C. |
| TSR | 25% | 22% | 22% |

Relative to the prior art (CE1) it is apparent that the plastics mouldings of the invention combine a comparable TSR with a significantly better heat distortion resistance.

### INDICATIONS RELATING TO THE DRAWING FIG. 1

FIG. 1: Extrusion mould

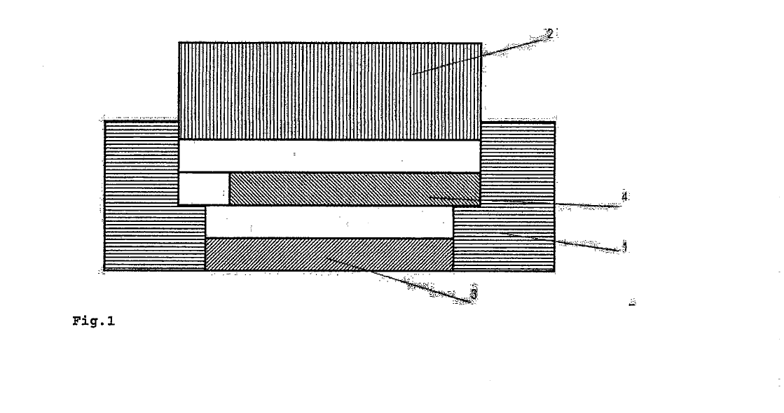

(1) Press ring

(2) Top plate

(3) Bottom plate

(4) Displacer disc

1. A dark-colored plastics molding, comprising:
a backing layer that is a polymer layer and
a top layer, comprising a transparent plastic,
wherein the backing layer, another layer that is not the top layer or both comprises an inorganic, IR-reflecting pigment,
a layer of the molding comprises a colorant, and
the plastics molding has a total solar reflectance (TSR) of at least 10%.

2. The molding of claim 1, wherein the top layer is a layer of polyamide, polyvinyl fluoride, polycarbonate, alkyl acrylate-styrene-acrylonitrile terpolymer, styrene-acrylonitrile copolymer, or poly(meth)acrylate.

3. The molding of claim 1, wherein the backing layer comprises a thermoplastic.

4. The molding of claim 1, wherein the backing layer comprises an inorganic, IR-reflecting pigment.

5. The molding of claim 1, further comprising:
another layer,
wherein a layer of the molding that is not a poly(meth)acrylate layer is an adhesive layer having a thickness of between 1 and 100 μm.

6. The molding of claim 5, wherein the adhesive layer is between the top layer and the backing layer.

7. The molding of claim 5, wherein the adhesive layer comprises an inorganic, IR-reflecting pigment.

8. The molding of claim 1, wherein the top layer is a PMMA film or sheet having a thickness of between 15 μm and 25 mm.

9. The molding of claim 1, wherein the top layer comprises the colorant.

10. The molding of claim 1, wherein a CieLab L* value is below 51.

11. The molding of claim 1,
wherein a layer comprising the inorganic, IR-reflecting pigment comprises between 0.01% and 5.0% by weight of the pigment, and
the inorganic, IR-reflecting pigment is a metal oxide having a particle size of between 50 nm and 5.0 μm.

12-14. (canceled)

15. The molding of claim 2, wherein the top layer is a layer of poly(meth)acrylate.

16. The molding of claim 3, wherein the backing layer comprises a total content of at least 50% by weight of PVF, PVDF, COC, COP, POM, ASA, SAN, polyester, polyamide, thermoplastic polyurethane, polycarbonate, ABS, or a combination thereof.

17. The molding of claim 11, wherein the metal oxide has a particle size of between 200 nm and 2.5 μm.

18. An element or module, comprising:
the molding of claim 1,
wherein the element or module is suitable for a facade, a roof of a building, a roof of a vehicle, or a vehicle part.

19. The element or module of claim 18, wherein the backing layer is on an outside of the element or module.

20. The element or module of claim 18, wherein the top layer is on an outside of the element or module.

21. A method of manufacturing an element or module, comprising:
manufacturing the element or module with the molding of claim 1,
wherein the element or module is suitable for a facade, a roof of a building, a roof of a vehicle, or a vehicle part.

22. The method of claim 21, wherein the backing layer is on an outside of the element or module.

23. The method of claim 21, wherein the top layer is on an outside of the element or module.
